(19) United States
(12) Patent Application Publication
(10) Pub. No.: US 2015/0206073 A1
(43) Pub. Date: Jul. 23, 2015

(54) Method and System for Providing Lighting Audits

(71) Applicant: PHILLIP BOGDANOVICH, Austin, TX (US)

(72) Inventor: PHILLIP BOGDANOVICH, Austin, TX (US)

(21) Appl. No.: 14/600,466

(22) Filed: Jan. 20, 2015

Related U.S. Application Data
(60) Provisional application No. 61/928,648, filed on Jan. 17, 2014.

(51) Int. Cl. G06Q 10/06; G06Q 40/00

(52) U.S. Cl. CPC G06Q 10/06; G06Q 40/00

(57) ABSTRACT

The disclosure provides a system for providing lighting audits. In embodiments, the system may comprise a network interface for receiving at least a portion of at least one average cost of lighting products, client productivity data, project information, and light fixture information.

The system may further provide a memory for storing average cost of lighting products, client productivity data, project information, and light fixture information.

The system may further provide a processor for processing the received average cost of lighting products, project information, and light fixture information to compare the average cost of lighting products and project information to the light fixture information.

The memory may provide a cost-effective replacement lighting setup for a client infrastructure.

The disclosure may further provide a method using the system provided in the disclosure.

### CROSS-REFERENCE TO RELATED APPLICATIONS

This application claims priority to U.S. Provisional Patent Application Ser. No. 61/928,648, filed Jan. 17, 2014, which is hereby incorporated by reference in its entirety.

### FIELD OF THE INVENTION

The present disclosure relates to a method and system for providing lighting audits.

### BACKGROUND OF THE INVENTION

The disclosed subject matter provides a method and system for providing lighting audits. The system may receive lighting audit information that may be processed and compared in order to provide a final audit report for a client.

### BRIEF SUMMARY OF THE INVENTION

The disclosed subject matter provides a method and system for providing lighting audits. In embodiments, the method may provide one or more steps for creating a proposal/audit for a lighting system.

In embodiments, the system may include a network interface for receiving at least a portion of at least one average cost of lighting products, client productivity data, project information, and light fixture information.

The system may further provide a memory for storing average cost of lighting products, client productivity data, project information, and light fixture information.

The system may further provide a processor for processing the received average cost of lighting products, project information, and light fixture information to compare the average cost of lighting products and project information to the light fixture information.

The memory may provide a cost-effective replacement lighting setup for a client infrastructure.

The disclosure may further provide a method using the system provided in the disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 depicts a flowchart of an exemplary embodiment of a method of the present disclosure.

FIG. 2 depicts an embodiment of an exemplary computing system and related peripherals that may operate with the method and system for providing lighting audits.

FIG. 3 depicts an exemplary embodiment of an electronically connected, networked, system operable for communicating information in relation to a lighting audit, the lighting audit information being on at least one of a sending computing system.

### DETAILED DESCRIPTION OF ILLUSTRATIVE EMBODIMENTS

Reference now should be made to the associated drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

Although described with reference to personal computers and the Internet, one skilled in the art could apply the principles discussed herein to any computing or mobile computing environment. Further, one skilled in the art could apply the principles discussed herein to communication mediums beyond the Internet.

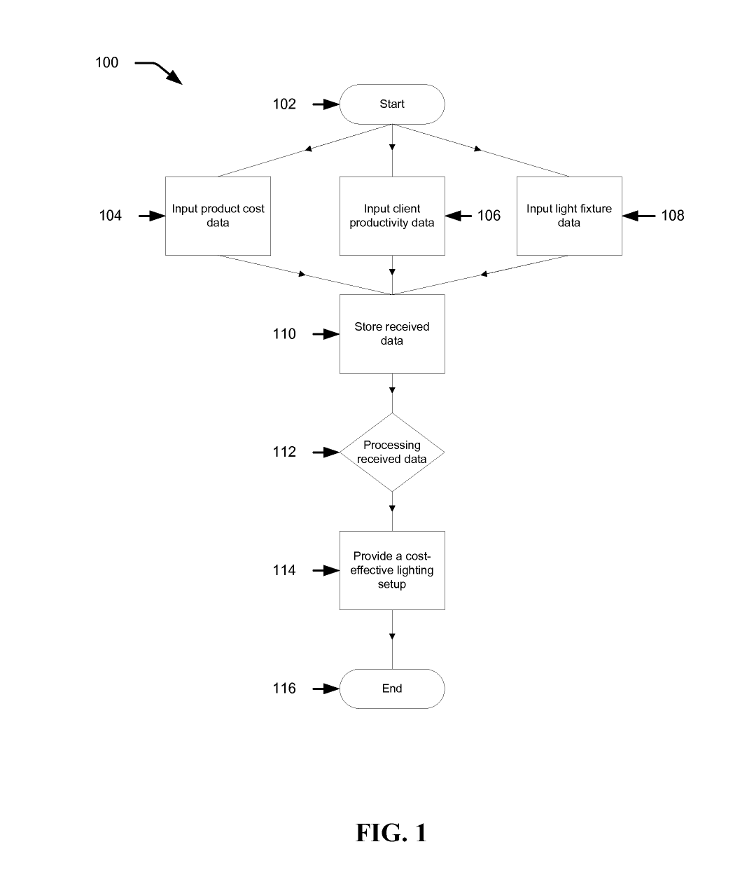

FIG. 1 depicts a flowchart of an exemplary embodiment of a method of the present disclosure. According to embodiments, a method for producing light audits may include receiving by a computing system 306, at least one average cost of lighting products 104, project information 106, and light fixture information 108 from one or more databases of one or more sending computing systems 302 connected to the network 308. The transfer of the information between the one or more sending computing systems 302 and the computer system 306 being through a suitable communications network 308. The computer system 306 may store the inputted information 104, 106, 108 in a memory therein. The method further including computer system 306 processing 112 at least a portion of the information 104, 106, 108 communicated by the one or more sending computer systems 302, and the computer system 306 providing 114 an output based on the processing. The output 114 generated by the computing system 306 may be communicated via the suitable communications network 308 from the computing system 306 to one or more of the sending computing systems 302 and/or one or more output computing systems 304.

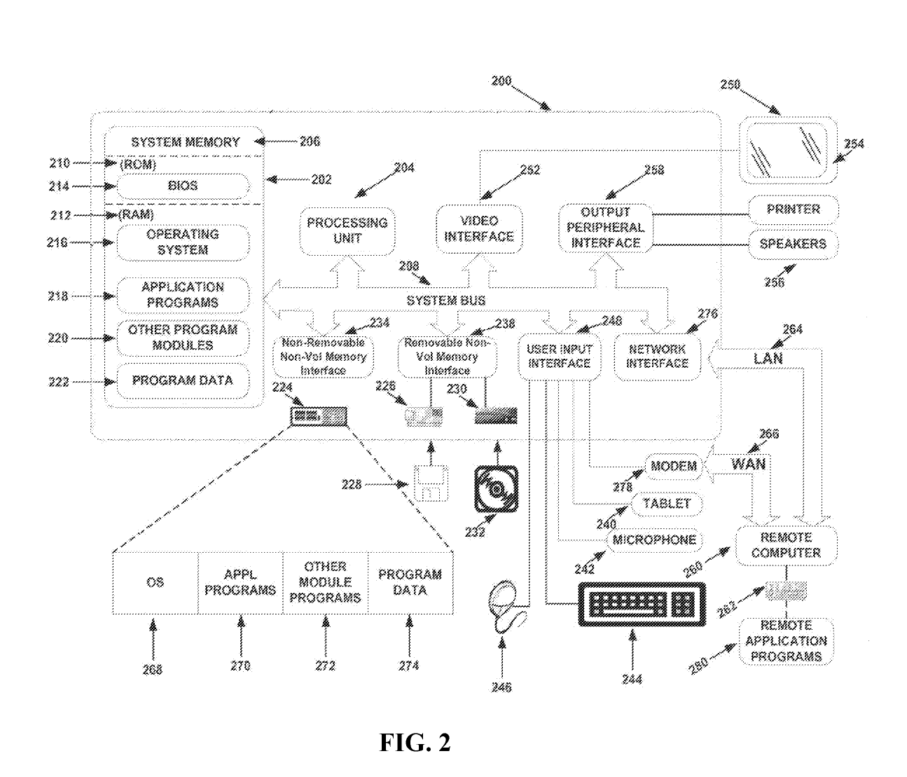

With reference to FIG. 2, an exemplary system within a computing environment for implementing the invention includes a general purpose computing device in the form of a computing system 200, commercially available from Intel, IBM, AMD, Motorola, Cyrix and others. Components of the computing system 202 may include, but are not limited to, a processing unit 204, a system memory 206, and a system bus 236 that couples various system components including the system memory to the processing unit 204. The system bus 236 may be any of several types of bus structures including a memory bus or memory controller, a peripheral bus, and a local bus using any of a variety of bus architectures.

Computing system 200 typically includes a variety of computer readable media. Computer readable media can be any available media that can be accessed by the computing system 200 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 200.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computing system 200, such as during start-up, is typically stored in ROM 210. RAM 212 typically contains data and/or program modules that are immediately accessible to and/or presently being operated on by processing unit 204. By way of example, and not limitation, an operating system 216, application programs 220, other program modules 220 and program data 222 are shown.

Computing system 200 may also include other removable/non-removable, volatile/nonvolatile computer storage media. By way of example only, a hard disk drive 224 that reads from or writes to non-removable, nonvolatile magnetic media, a magnetic disk drive 226 that reads from or writes to a removable, nonvolatile magnetic disk 228, and an optical disk drive 230 that reads from or writes to a removable, nonvolatile optical disk 232 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 224 is typically connected to the system bus 236 through a non-removable memory interface such as interface 234, and magnetic disk drive 226 and optical disk drive 230 are typically connected to the system bus 236 by a removable memory interface, such as interface 238.

The drives and their associated computer storage media, discussed above, provide storage of computer readable instructions, data structures, program modules and other data for the computing system 200. For example, hard disk drive 224 is illustrated as storing operating system 268, application programs 270, other program modules 272 and program data 274. Note that these components can either be the same as or different from operating system 216, application programs 220, other program modules 220, and program data 222. Operating system 268, application programs 270, other program modules 272, and program data 274 are given different numbers hereto illustrates that, at a minimum, they are different copies.

A user may enter commands and information into the computing system 200 through input devices such as a tablet, or electronic digitizer, 240, a microphone 242, a keyboard 244, and pointing device 246, commonly referred to as a mouse, trackball, or touch pad. These and other input devices are often connected to the processing unit 204 through a user input interface 248 that is coupled to the system bus 208, but may be connected by other interface and bus structures, such as a parallel port, game port or a universal serial bus (USB).

A monitor 250 or other type of display device is also connected to the system bus 208 via an interface, such as a video interface 252. The monitor 250 may also be integrated with a touch-screen panel or the like. Note that the monitor and/or touch screen panel can be physically coupled to a housing in which the computing system 200 is incorporated, such as in a tablet-type personal computer. In addition, computers such as the computing system 200 may also include other peripheral output devices such as speakers 254 and printer 256, which may be connected through an output peripheral interface 258 or the like.

Computing system 200 may operate in a networked environment using logical connections to one or more remote computers, such as a remote computing system 260. The remote computing system 260 may be a personal computer, a server, a router, a network PC, a peer device or other common network node, and typically includes many or all of the elements described above relative to the computing system 200, although only a memory storage device 262 has been illustrated. The logical connections depicted include a local area network (LAN) 264 connecting through network interface 276 and a wide area network (WAN) 266 connecting via modem 278, but may also include other networks. Such networking environments are commonplace in offices, enterprise-wide computer networks, intranets and the Internet.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

Data shared and/or used in the various embodiments can also be shared and/or used via a traditional web site or to populate a web site (or other medium). This allows information already assembled in one or more of the other embodiments to be repurposed and thereby raise the value of the disclosed subject matter.

Examples of computing devices such as that depicted in FIG. 2 can include, but are not limited to, portable or mobile devices such as mobile phones (including smartphones), laptop computers, tablet computers, personal digital assistants (PDAs), or non-portable devices such as desktop computers, servers, mainframes, and the like. Such computing devices include, in some examples, various components, such as one or more processors, input devices, communication devices, output devices, storage devices, communications busses, or other components. Each of the components can be interconnected (physically, communicatively, and/or operatively) for inter-component communications. In some examples, the one or more processors of a computing device can execute an operating system that controls operations of components of the computing device, such as by facilitating communication between components of the computing device.

Processors of the computing device, in some examples, are configured to implement functionality and/or process instructions within the computing device. For instance, one or more processors of the computing device can be capable of processing instructions stored in one or more storage devices of the computing device. Examples of such processors can include any one or more of a microprocessor, a controller, a digital signal processor (DSP), an application specific integrated circuit (ASIC), a field-programmable gate array (FPGA), or other equivalent discrete or integrated logic circuitry.

One or more storage devices of a computing device can be configured to store information within the computing device during operation. Such storage devices can be described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, a storage device can be a temporary memory, meaning that a primary purpose of the storage device is not long-term storage. Storage devices, in some examples, can be described as volatile memory, meaning that the storage device does not maintain stored contents when power to the computing device is turned off. Examples of volatile memories can include random access memories (RAM), dynamic random access memories (DRAM), static random access memories (SRAM), and other forms of volatile memories. In some examples, a storage device can be used to store program instructions for execution by one or more processors. Storage devices, in certain examples, can be used by software or applications running on the computing device to temporarily store information during program execution.

Storage devices, in some examples, also include one or more computer-readable storage media. Storage devices can be configured to store larger amounts of information than volatile memory. Storage devices can further be configured for long-term storage of information. In some examples, storage devices can include non-volatile storage elements. Elements of such non-volatile storage elements can include magnetic hard discs, optical discs, floppy discs, flash memories, or forms of electrically programmable memories (EPROM) or electrically erasable and programmable (EEPROM) memories.

A computing device can, in some examples, include one or more communication devices. For instance, a computing device can utilize a communication device to communicate with external devices via one or more networks, such as wired or wireless networks or both. A communication device can be a network interface card, such as an Ethernet card, an optical transceiver, a radio frequency transceiver, or any other type of device that can send and receive information. Other examples of such network interfaces can include, but are not limited to, Bluetooth, 3G, 4G, WiFi radio computing devices, as well as Universal Serial Bus (USB).

In certain examples, a computing device can utilize a communications device to communicate with one or more external devices via a communications network. In some examples, components of Platform can be distributed among multiple computing devices, which can be interconnected via the communications network. Examples of such a communications network can include one or more wired or wireless networks or both, such as local area networks (LANs), wireless local area networks (WLANs), cellular networks, wide area networks (WANs) such as the Internet, or other types of networks.

A computing device can also include one or more input devices and/or output devices. An input device, in some examples, can be configured to receive input from a user. Examples of input devices can include any one or more of a mouse, a keyboard, a microphone, a camera device, a presence-sensitive and/or touch-sensitive display, or other type of device configured to receive input from a user. Output devices can be configured to provide output to a user. Examples of output devices can include a display device, a sound card, a video graphics card, a speaker, a cathode ray tube (CRT) monitor, a liquid crystal display (LCD) an organic light emitting diode (OLED) display, or other type of device for outputting information.

Accordingly, techniques of this disclosure can be implemented by one or more computing devices implementing computer-readable instructions that, when executed, cause the one or more computing devices to perform operations attributed to the Platform system. The Platform system is further described below within the context of various scenarios, illustrations, and further description.

For the purposes of this disclosure, it is appreciated that the terms “device”, “processor based mobile device”, “mobile device”, “electronic device”, “processor based mobile electronic device”, “mobile electronic device”, and “location-capable wireless device” may be synonymous with remote computer 200. Furthermore, any of the above terms may be synonymous with the terms “computing system”, “sending computing system”, and “output computing system”.

While this disclosure has been particularly shown and described with reference to preferred embodiments thereof and to the accompanying drawings, it will be understood by those skilled in the art that various changes in form and details may be made therein without departing from the spirit of this disclosure. Therefore, the scope of the disclosure is defined not by the detailed description but by the appended claims.

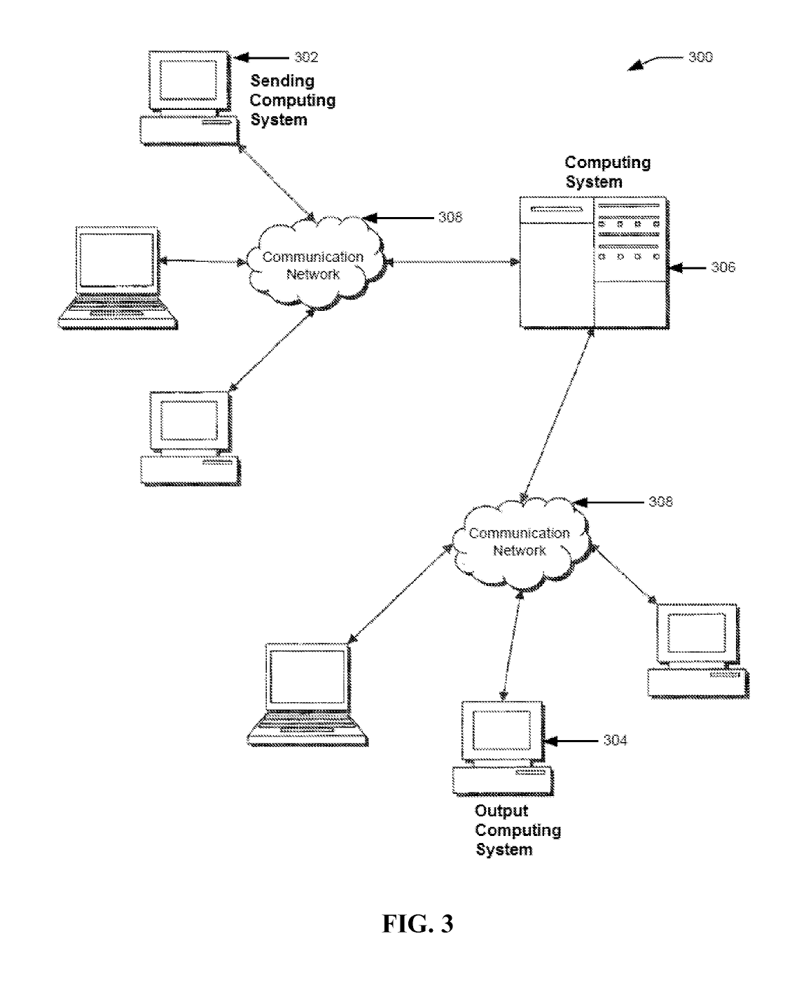

Illustrated in FIG. 3 is an exemplary embodiment of an electronically connected, networked, system 300 operable for communicating information in relation to a lighting audit, the lighting audit information being on at least one of a sending computing system 302. Without limitation, in embodiments as shown in FIG. 3, system 300 may include a computing system 306 comprising a network adapter, the computing system 306 operable for communication via the network adapter over a suitable communication network 308 with the sending computing system 302. The computing system 306 operable to receive from the sending computing system 302 a communication including information related to at least one of at least one average cost of lighting products, project information, light fixture information, or some combination thereof. Furthermore, as shown in FIG. 3, in embodiments system 300 may include the computing system 306 including memory, wherein the memory may be configured for storing the at least part of the information received from the sending computer system 302.

Without limitation, in embodiments as shown in FIG. 3, system 300 may include the computing system 306 comprising a processor in communication with the memory, the processor operable for processing information from the memory. The processor operable to perform processing comparing at least a portion of the at least one average cost of lighting products, project information, light fixture information, and combinations thereof. The computing system 306 operable to communicate to the sending computing system 302 and/or one or more output computing systems 304 returned information, the returned information being the results of the processing of the lighting audit information.

The lighting audit system may perform various functions relative to what the lighting audit system may display. Displayed primary components may comprise, but are not limited to: a general data section, a site information section, a space evaluation section, a totals section, a bid section, a summary section, a remote aggregating data server section, and a final proposal section. The system may provide to a client an audit concerning a lighting infrastructure. In embodiments, the term “lighting audit system” may refer to the entire system setup found in FIG. 3. In other embodiments, the term “lighting audit system may refer to computing system 200. In other embodiments, computing system 306 and computing system 200 may be synonymous.

The general data section may be a screen on the display of the lighting audit system that may display information relative to ballasts and lamps. The lighting audit system may link wirelessly or by a wired connection to a ballast database and/or a lamp database. The ballast database may comprise average costs and wattage conversions for ballasts. The lamp database may comprise average costs and wattages for lamps. The above databases may be contained in a single server. Lamps may include, but are not limited to fluorescent tubes, compact fluorescent bulbs, household bulbs, and incandescent bulbs. The averages may then be compared to a single manufacturer of ballasts and/or lamps. The data comprising the averages may be found at any given time and compared with a single entity's data found in the single entity's server in order to supply an individual with comparative information.

A second data section may be an alternative screen on the display of the lighting audit system that may allow a client to apply for a specific tier of professional license (each tier may correlate to different discount levels). At any point in time after the client applies, the client may be automatically upgraded or downgraded within the system based on their volume of sales. The tier level may be displayed on a screen representative of a client preferences section.

Tier one parameters may comprise the following: commercial clients that rack up total unit sales of 5,000 or more units per month. Tier one qualifiers may receive a 30 percent reduction in product cost per unit through all product lines. Tier two parameters may comprise the following: commercial clients that rack up total unit sales from between 1,000 and 4,999 units per month. Tier two qualifiers may receive a 20 percent reduction in product cost per unit through all product lines. Tier three parameters may comprise the following: commercial clients that rack up total unit sales from between 500 and 999 units per month. Tier three qualifiers may receive a 10 percent reduction in product cost per unit through all product lines. In further embodiments, the parameters and discounts for each tier may vary.

The site information sheet section may be an alternative screen on the display of the lighting audit system that may allow a client to input general information relative to the client and specific information relative to an infrastructure for a potential audit. The information may include, but is not limited to: job name, project owner (client/other company), point of contact, phone number for point of contact, fax number for point of contact, email for point of contact, physical address for job site, known types of lights being replaced, types of lights being proposed, delivery, installation, known or estimated energy costs, burn hours per day, work days per week, type of space being audited, available rebates, cost of skilled labor, and cost of non-skilled labor.

The information required from a client may be entered manually using a keypad or entered using an engageable drop-down menu. In embodiments, the known types of lights may be entered using a drop-down menu and may comprise incandescent, metal halide, fluorescent, and mixed lighting. In embodiments, the proposed lights may be entered using a drop-down menu and may comprise LED, fluorescent, and other. In embodiments, delivery and installation options may be chosen from a drop-down menu. The options may be “yes” or “no”. In embodiments, the energy costs may be entered manually. The energy costs may be measured in kilowatt hours (KWH). The burn hours per day may be representative of the hours per day that lights are on. The burn hours per day may refer to the amount of hours per day that one or more lights are on. In embodiments, the burn hours per day may be entered manually. In other embodiments, the burn hours per day may be chosen from a drop-down menu.

In embodiments, the work days per week may be entered manually and may be based on an average or estimate. In embodiments, the type of space being audited may be chosen from a drop-down menu. Examples of spaces may include, but are not limited to commercial, manufacturing, residential, retail, distribution, office space, general, and other. In embodiments, the default selection may be commercial.

In embodiments, the available rebates section may be completed utilizing available rebates from local energy providers. This section may be completed utilizing a numeric value in conjunction with a drop-down selection of either reduction per kilowatt-hour, or reduction per kilowatt. In embodiments, an option may also exist to populate the proposal forward utilizing statistically available information. For example, an auditor has the option of auto-generation. If the autogeneration tab is selected, it may instruct the application to search for rebates available in the area in which the audit is being performed, and to suggest potential available rebates.

In embodiments the cost of skilled labor section may be populated either using a specific cost provided by the auditee or an estimate based on the cost of skilled labor average for the area in which the audit is taking place. This cost may be utilized in conjunction with ballast failure rates and ballast costs, as well as lamp failure rates and lamp costs to determine the monthly and annual cost of maintenance for an existing or proposed system. An auto-populate tab may be available. When “auto-populate” is selected, it may base the cost of skilled labor on whatever is found to be an average through a database search in that particular area (GPS-driven). The preferred method may be to utilize numbers provided by the auditee.

In embodiments, the cost of non-skilled labor section may be populated either using a specific cost provided by the auditee or an estimate based on the cost of non-skilled labor averages for the area in which the audit is to take place. This cost may be utilized in conjunction with ballast failure rates, ballast costs, light failure rates, and lamp costs in order to determine monthly and annual cost of maintenance for an existing or proposed system. An auto-populate tab may be available. When “auto-populate” is selected, it may base the cost of non-skilled labor on what is found to be an average through a database search in that particular area (GPS-driven). In embodiments, the preferred method may be to utilize numbers provided by the auditee.

In embodiments, at the top of the Site Information Page may be a tab offering to auto-populate any data based on either GPS location, auto-populate data based on available contact, or the default manual entry.

In embodiments, auto-populating based on GPS location may utilize the GPS in the mobile electronic device of a client and may access available job site databases. Based on the physical location of the phone, the sheet may populate based on the known business residing in that space.

In embodiments, if “auto-populate based on available contact” is selected, the mobile electronic device may offer the auditor the option to search for an existing contact in their mobile device and may populate the information sheet based on the data stored for a particular contact. In embodiments, if the manual option is selected, each individual space may need to be completed manually.

In embodiments, an option may be selected in settings for the Site Information Section to switch on the autopopulate section for, but not limited to, the following: KWH rate, burn hours, days per week, installation, delivery, and auto-populate client information based on GPS location. The auditor may be able to select via slider which of these options may be set to auto-populate, if any.

The space evaluation section may be an alternative screen on the display of the lighting audit system that may allow an auditor to input light fixture information relative to an infrastructure for a potential audit. The space evaluation section may consist of a drop-down menu that may allow for an auditor to select the type of light fixtures being evaluated as well as the fixture count per space. The light count per space section may be operated via up and down arrows that when clicked may produce an audible “click.” This audible “click” may serve as a counter by which the auditor can select the number of fixtures in a given space. This section may feature a “next” button that may immediately precede the “number of fixtures” section. Each time the “next” button is clicked, another drop-down menu may appear. This process may be repeated for each light fixture type in the space being audited. As an example, 12 four-lamp T8 parabolic fixtures may be represented as “4-lamp T8 parabolic fixture” selected from the drop-down menu of fixture types with a light count of 12 selected by clicking up to a light count of 12.

In embodiments, optional tabs in this space may represent average foot-candle (FC) reading and average mounting height per fixture type. Selecting the average FC reading and average mounting height may be for reference purposes once an audit is completed. Because this may be a retrofit audit and each light type may have a prescribed replacement lamp, the mounting height and FC readings may typically be irrelevant when a replacement light type is selected because each light selected as a replacement by the lighting audit system is designed to replace each type of existing light, one for one.

Presumably, if the existing light produces a sufficient quantity of light, the replacement product may also provide a sufficient amount of light. In the event that the existing lights do not produce sufficient quantities of light, a different light type may be selected manually at the completion of the audit. The average FC readings and the average mounting heights may be included in the summary section of the application.

In embodiments, at the bottom of each separate space evaluation screen, there may be a tab to fill in the operational hours or burn hours per day, as well as work hours per week. This information may be utilized to aggregate the total average burn hours per year for the entire envelope being audited. The lighting audit system may utilize this information to determine appropriate savings and return on investment for the entire envelope based on the average burn hours provided.

In embodiments, at the bottom right corner of each space evaluation screen, there may be a “back” button, a “next” button, and a “finish” button. When the “back” button is clicked, an animated transition may occur that may show the screen being rolled to the right. This may mimic turning the pages in a book. Following the rollback to the right, the previous screen viewed may once again become visible. This transition may occur all the way back to the first page completed (the first page being the site information page).

In embodiments, when the “next” button is clicked, an animated transition may occur that may show the page being rolled back to the left. This may mimic turning the pages in a book. When this animation has completed, a new blank page may be presented. This blank page may represent a new space within the envelope being audited. This process may continue until all spaces are accounted for. Once all spaces are accounted for, the “completed” button may be clicked.

In embodiments, when the “completed” button is clicked, an animation may occur, with this final space information screen rolling back to the left one final time to present a “totals” section.

In embodiments, at the bottom and center of each sheet in the space evaluation screen section, there may be a blank tab where the name of each space within the envelope being audited may be named.

The totals section may be an alternative screen on the display of the lighting audit system that may auto-populate. On this screen, the total number of fixtures, total number of lights, type of lights, and type of fixtures as well as the presumed performance data for each type of fixture being replaced may be shown and broken out per space. At the bottom of this section, absolute totals may be displayed that may show in line, item form each type of fixture, each type of light, and the presumed performance information on each item named. In embodiments, this section may provide a snapshot of the entire envelope.

The bid section may be an alternative screen on the display of the lighting audit system that may reflect proposed replacement lamps for each light type evaluated during an audit process. The bid section may reflect not only the information from the totals section, but may also display the pertinent information for each proposed replacement lamp.

This information may be presented separately as the categories in the following paragraph.

In embodiments, the single line per fixture type may be the total number of lights being replaced, type of lights being replaced, replacement light type, replacement light description, replacement light color, replacement light lens type, replacement light wattage, replacement light unit cost, total cost for this specific quantity and type of replacement light.

In embodiments, the total number of lights being replaced (quantity) may auto-populate based on the totals of the totals section.

In embodiments, the type of lights being replaced may auto-populate based on the totals of the totals section.

In embodiments, the replacement light type may auto-populate based on the prescribed replacement lamp for each light type encountered during an audit process. The information may be the product code corresponding to the appropriate replacement lamp. If an auditor so chooses, he or she may change this value and manually enter a different type of light.

In embodiments, the replacement light description may auto-populate based on the prescribed replacement lamp for each light type encountered during the audit process. The information may be the actual product description corresponding to the product code represented in a previous section. If an auditor so chooses, he or she may change this value and manually enter a different type of light.

In embodiments, the replacement light color may be a dynamic block and an auditor may choose which color he or she would like to specify for a project. The options represented in this section may be specific to the replacement light being specified. As an example, a 100 W LED floodlight may not provide a color choice of 2700 Kelvin because a 2700 Kelvin 100 W floodlight may not be a produced light. Instead, other options may include, but are not limited to 4000, 5000, and 6000 Kelvin.

In embodiments, the replacement lens type may be a dynamic section and an auditor may choose which lens type he would like to specify for a project. Lens types represented in this block may be specific to the replacement light being specified. For example, a 100 W Hyperion LED floodlight may not be provided as a lens choice of frosted because a 100 W LED flood with a frosted lens may not be produced. Instead, for a 100 W LED floodlight, the lens options available in this section provided in a drop-down format may be clear or prismatic.

In embodiments, the replacement light wattage may auto-populate based on the performance data for the light specified as a replacement by database information. For example, the replacement light for a 32 W T8 may be an 18 W 4-foot tube. In this instance, the section may auto-populate with a value of 18. Should an auditee have chosen to manually enter light types, this section may be left blank to be completed by the auditor.

In embodiments, the replacement ballast wattage may auto-populate based on the performance data for the light specified as a replacement by a database. For example, a replacement light for a 32 W T8 may be an 18 W 4-foot tube. In this instance, the section may auto-populate with a value of 0 because this particular lamp does not utilize a ballast. Should an auditee have chosen to manually enter light types, this section may be left blank to be completed by the auditor.

In embodiments, the replacement light unit cost may auto-populate based on the performance data for the light specified as a replacement the database. For example, a replacement light for a 32 W T8 may be a 18 W 4-foot tube.

The cost of this product retail may be $48.00. This section may auto-populate with a value of 48. Should an auditee have chosen to manually enter light types, this section may be left blank to be completed by the auditor.

In embodiments, the total cost for the specific quantity and type of replacement light may auto-populate based on the quantity of lights specified multiplied by the unit cost of the replacement lights specified. For example, a replacement light for a 32 W T8 may be an 18 W 4-foot LED tube. If the quantity of lights registers a quantity of 10 and the unit cost of the replacement lights registers a value of 48, the total cost to retrofit this quantity and specific type of light may be $480 (Or 10×48).

The information completed and compiled inside of the bid section may be used to generate data graphical representations of the return on investment, total project cost, cost of waiting, environmental impact data, and any other financial graphs revolving around the total project cost. This information may be represented not only in the final proposal but also in value form in a summary section.

The summary section may be an alternative screen on the display of the lighting audit system that may contain a detailed summary of all values originating from this audit. It may show the lamp count as well as the fixture count as represented in a totals section.

In embodiments, the summary section may also display the total bid cost for a project as well as the type and quantity of each proposed replacement lamp. In embodiments, the section may display a minimum, maximum, and average mounting height for each fixture type accounted for during the audit process. In embodiments, this section may also contain the total average or “mean average burn” hours per day, work days per week, work days per year, and burn hours per year. In embodiments, this section may estimate the average foot-candle for each space as well as the average footcandles read beneath each type of fixture, as well as the average foot-candles represented for an entire envelope. In embodiments, this section may show the maintenance time and maintenance costs represented on the site information sheet and may indicate whether installation and shipping is to be accounted for. In embodiments, the bottom left corner of the section may display a “finish” button. When this button is clicked, the information contained within this section may be sent to a server for processing.

The remote server section may be an alternative screen on the display of the lighting audit system that may aggregate the data contained within the summary information sheet submitted by an auditor. In embodiments, this information may be aggregated using the methods and formulas outlined in a “formulas and aggregation information” section. The data generated by a server of the computing system during this process may be transitioned into PDF format and emailed back to the auditor who completed submission. The PDF report that may be generated may be sent to the email address specified during a customer setup phase.

The final proposal server section may be an alternative screen on the display of the lighting audit system that may contain both written information and data graphical information pertinent to an audit completed and submitted by one or more auditors. The proposal may be specific to data submitted. In embodiments, a variation may be the “benefits” information outlined in the “benefits” section of the proposal. Information contained therein may be determined by the proposed lighting type selections made during the completion of the site information sheet. For example, LEDs selected during the completion of the site information section may lead to a benefits section containing specific benefits of utilizing LED lighting.

For the purposes of this disclosure, the terms “lighting audit system”, “system”, and “computing system” may be synonymous.

For the purposes of this disclosure, the terms “user”, “client”, and “auditee” may be synonymous.

For the purposes of this disclosure, the terms “section” and “page” are synonymous.

For the purposes of this disclosure, an instance of a section may refer to a screen found on a client's electronic device and/or a computing system 200 screen that may be capable of displaying information relevant and not relevant to a lighting audit.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

What is claimed is:

1. A method for producing lighting audits comprising:
receiving at a network interface at least one average cost of lighting products from a database of a computing device connected to the network interface over a network;
receiving at a network interface client productivity data from a computing device connected to the network interface over a network;
receiving at a network interface project information from a computing device connected to the network interface over a network;
receiving at a network interface light fixture information from a computing device connected to the network interface over a network;
processing at least a portion of the at least one average cost of lighting products, project information, and light fixture information using a processor to compare at least a portion of the at least one average cost of lighting products and project information to at least a portion of the light fixture information;
and
based on the comparing by the processor, providing a cost-effective replacement lighting setup for a client infrastructure.

2. The method of claim 1, wherein a client infrastructure is an infrastructure is selected from the group consisting of: commercial, manufacturing, residential, retail, distribution, office space, and general.

3. A system for producing lighting audits comprising:
a network interface for receiving at least a portion of at least one average cost of lighting products, client productivity data, project information, and light fixture information from a computing device connected to the network interface over a network;
a memory storing the at least a portion of at least one average cost of lighting products, client productivity data, project information, and light fixture information;
and
a processor for processing the received at least a portion of the at least one average cost of lighting products, project information, and light fixture information to compare at least a portion of the at least one average cost of lighting products and project information to at least a portion of the light fixture information;
wherein the memory is controlled by the processor to, based on the comparing by the processor, provide a cost-effective replacement lighting setup for a client infrastructure.

4. The system of claim 3, wherein a client infrastructure is an infrastructure is selected from the group consisting of: commercial, manufacturing, residential, retail, distribution, office space, and general.
